(19) United States
(12) Patent Application Publication
(10) Pub. No.: US 2008/0139225 A1
(43) Pub. Date: Jun. 12, 2008

(54) APPARATUS AND METHOD FOR DISPLAYING A CALL HISTORY

(75) Inventors: Kuan-Hong Hsieh, Shenzhen City (CN); Hua-Dong Cheng, Shenzhen City (CN); Wen-Chuan Lian, Shenzhen City (CN); Han-Che Wang, Shenzhen City (CN); Xiao-Guang Li, Shenzhen City (CN); Shin-Hong Chung, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/846,534

(22) Filed: Aug. 29, 2007

(30) Foreign Application Priority Data
Dec. 8, 2006 (CN) 200610201257.9

(51) Int. Cl. H04Q 7/20

(52) U.S. Cl. 455/456.3

(57) ABSTRACT

The present invention relates to a mobile communication terminal. The mobile communication terminal includes a display unit; a storage unit for storing communication records and communication frequencies of each of the communication records in a particular time period; and a processing unit, configured for controlling the display unit to display a subset of the communication records in the particular time period, wherein the communication records are sorted according to the associated communication frequencies, and divided into two parts, wherein the two parts of the sorted communication records are listed in an alphabetical order respectively. The present invention also provides a call history displaying method adapted for the mobile communication terminal.

### BACKGROUND OF THE INVENTION

1. Field of the Invention

The present invention relates to a mobile communication terminal, and more particularly, to a call history displaying method of the mobile communication terminal.

2. General Background

In a mobile communication terminal (i.e. a mobile phone), it is inefficient for a user who frequently calls a certain party to dial all digits of that party telephone number each time. To solve the inefficiency, mobile phones have been provided with a phone book function for storing frequently used telephone numbers for future use. But when dialing a telephone number using the phone book function, the user must press a function key and a scroll key one or many times to retrieve the desired telephone number. Therefore, the user will spend a long time to retrieve a desired telephone number.

Another technique that has been introduced to facilitate dialing has been to equip the mobile phone with a communication history list. The communication history list has a particular storage for storing the telephone numbers communicated (i.e. dialed, missed or received) recently. The telephone numbers are listed according to a temporal order they have been communicated; typically, the most recent one will be listed first. Consequently, when a user wants to dial a particular telephone number communicated recently, they may have to spend more time retrieving the desired telephone number from the communication history list. In addition, some of the telephone numbers listed may repeatedly appear when they are communicated many times. As a result, the repetitive telephone numbers may fill up the list with important but less frequent communicated numbers being dropped from the list. The repetitive numbers may also reveal potentially damaging information if the mobile phone gets into the wrong hands. This information can be detrimental to both the owner of the mobile phone and the person calling or being called.

### SUMMARY OF THE INVENTION

A mobile communication terminal is provided. The mobile communication terminal includes a display unit; a storage unit for storing communication records and communication frequencies of each of the communication records in a particular time period; and a processing unit, configured for controlling the display unit to display a subset of the communication records in the particular time period, wherein the communication records are sorted according to the associated communication frequencies, and divided into two parts, wherein the two parts of the sorted communication records are listed in an alphabetical order respectively.

A call history displaying method adapted for a mobile communication terminal is provided. Wherein the mobile communication terminal comprises a storage unit for storing communication records and communication frequencies of each of the communication records in a particular time period, the method includes the steps of: (a) sorting the communication records according to the associated communication frequencies in the particular time period; (b) reading a predetermined number of the sorted communication records in order; (c) sorting the read communication records in an alphabetical order to generate a first list; (d) sorting the remaining communication records of the sorted communication records in the alphabetical order to generate a second list; (e) merging the first list and the second list to generate a call history of the particular time period, wherein the first list is listed prior to the second list; and (f) displaying the call history.

Other advantages and novel features will be drawn from the following detailed description with reference to the attached drawing.

### BRIEF DESCRIPTION OF THE DRAWINGS

FIG. 1 is a block diagram of a mobile communication terminal in accordance with a preferred embodiment of the present invention; and

FIG. 2 is a flow chart illustrating a preferred call history displaying method which is performed by the mobile communication terminal of FIG. 1.

### DETAILED DESCRIPTION OF THE INVENTION

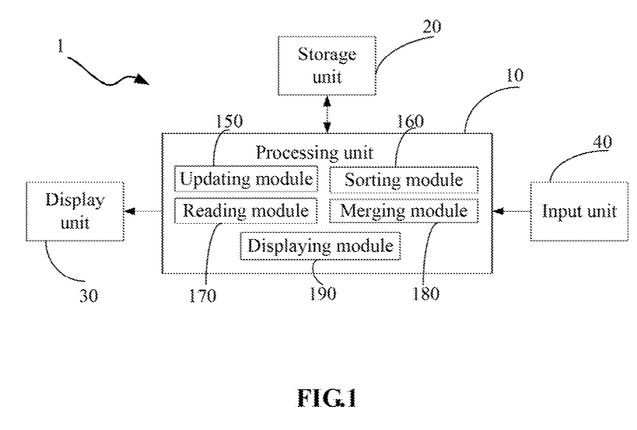

FIG. 1 is a block diagram of a mobile communication terminal in accordance with a preferred embodiment of the present invention. The mobile communication terminal (hereinafter, “the terminal”) 1 includes a processing unit 10, a storage unit 20, a display unit 30, and an input unit 40. The input unit 40, typically including a plurality of keys, is configured for receiving user input operations and generating input signals. The storage unit 20 is configured for storing communication records and communication frequencies of each of the communication records in a particular time period. Each of the communication records may include a name, a telephone number, a date of the last communication, and a time of the last communication. The display unit 30 is configured for displaying information, such as a liquid crystal display (LCD) or an electronic ink (E-ink) display. The processing unit 10 is configured for controlling the display unit 30 to display a subset of communication records in the particular time period.

The processing unit 10 includes an updating module 150, a sorting module 160, a reading module 170, a merging module 180, and a displaying module 190. When the terminal 1 generates a new call, such as a missed call, a received call, or a dialed call, the updating module 150 updates the communication records in the particular time period, thereby yielding updated communication records. Wherein each updated communication record has a corresponding communication frequency, the sorting module 160 sorts the updated communication records in descending order according to the associated communication frequencies, thereby yielding sorted communication records. The reading module 170 reads a predetermined number of the sorted communication records in order, that is from high to low according to the associated communication frequencies, thereby yielding read communication records. The sorting module 160 sorts the read communication records in an alphabetical order according to names of the read communication records and generates a first list.

After generating the first list, the sorting module 160 also sorts remaining communication records of the sorted communication records in the alphabetical order of the names of the remaining communication records to generate a second list. The merging module 180 merges the first list and the second list to generate a call history of the particular time period, wherein the first list is listed prior to the second list in the call history. The call history includes two parts, the first list and the second list. The storage unit 20 stores the call history. When the terminal 1 receives a request instruction from the input unit 40, the displaying module 190 displays a subset of the call history on the display unit 30.

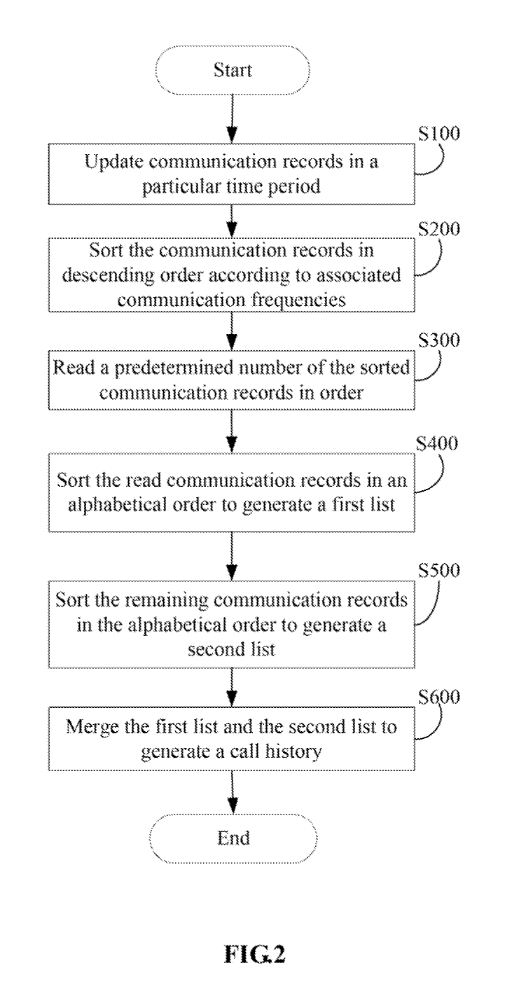

FIG. 2 is a flow chart illustrating a call history displaying method which is performed by the mobile communication terminal 1 of FIG. 1. In step S100, namely when the terminal 1 generates a new call, such as a missed call, a received call, or a dialed call, the updating module 150 updates communication records in a particular time period in the storage unit 20. In step S200, the sorting module 160 sorts the updated communication records in descending order according to associated communication frequencies in the particular time period. In step S300, the reading module 170 reads a predetermined number of the sorted communication records in order, that is from high to low according to the associated communication frequencies. In step S400, the sorting module 160 sorts the read predetermined number of the communication records in an alphabetical order according to the names of the communication records to generate a first list. In step S500, the sorting module 160 sorts the remaining communication records of the updated communication records in the alphabetical order according to the names to generate a second list. In step S600, the merging module 180 merges the first list and the second list to generate a call history in the particular time period, wherein the first list is listed prior to the second list in the call history.

In order to embody the present invention, an example is presented below. In the example, the particular time period is a week, and there are an aggregated total of 16 communication records in the week. The communication statistics of each of the communication records in the storage unit 20 are shown in Table 1 as follows:

TABLE 1

| Communication records | Communication frequencies |
|---|---|
| Lily | 3 |
| Angel | 19 |
| Clark | 23 |
| Lucy | 6 |
| Andy | 28 |
| John | 23 |
| David | 15 |
| Tony | 24 |
| Lincoln | 22 |
| Wendy | 17 |
| Gary | 9 |
| Linda | 18 |
| Scott | 20 |
| Whitney | 25 |
| Amanda | 10 |
| Leon | 1 |

For simplicity, the predetermined number is 10, and the display unit 30 is able to display 8 communication records at a time. The two lists displayed on the display unit 30 are shown in Table 2 and Table 3 as follows:

TABLE 2

Andy
Angel
Clark
John
Lincoln
Linda
Scott
Tony

TABLE 3

Wendy
Whitney
Amanda
David
Gary
Leon
Lily
Lucy

Therefore, the call history of the terminal 1 derives from Table 2 and Table 3. When receiving a request about other information of a communication record from the input unit 40, the display unit 30 displays a telephone number, a date of the last communication, and a time of the last communication.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A mobile communication terminal comprising:
a display unit;
a storage unit for storing communication records and communication frequencies of each of the communication records in a particular time period; and
a processing unit, configured for controlling the display unit to display a subset of the communication records in the particular time period, wherein the communication records are sorted according to the associated communication frequencies, and divided into two parts, wherein the two parts of the sorted communication records are listed in an alphabetical order respectively.

2. The mobile communication terminal as recited in claim 1, wherein the communication records are sorted in descending order according to the associated communication frequencies.

3. The mobile communication terminal as recited in claim 1, wherein each of the communication records includes a name, a telephone number, a date of the last communication, and a time of the last communication.

4. A mobile communication terminal, comprising a display unit, a processing unit, and a storage unit for storing communication records and communication frequencies of each of the communication records in a particular time period, wherein the processing unit comprises:
a sorting module for sorting the communication records according to the associated communication frequencies in the particular time period, sorting a predetermined number of the sorted communication records in an alphabetical order to generate a first list, and sorting the remaining part of the sorted communication records in the alphabetical order to generate a second list;
a reading module for reading the predetermined number of the sorted communication records in order;
a merging module for merging the first list and the second list to generate a call history in the particular time period, wherein the first list is listed prior to the second list; and
a displaying module for displaying the call history on the display unit.

5. The mobile communication terminal as recited in claim 4, wherein the communication records are sorted in descending order according to the associated communication frequencies in the particular time period.

6. The mobile communication terminal as recited in claim 4, wherein each of the communication records includes a name, a telephone number, a date of the last communication, and a time of the last communication.

7. The mobile communication terminal as recited in claim 4, wherein the processing unit further comprises an updating module, wherein when the mobile communication terminal generates a new call, the updating module updates communication records in the particular time period.

8. The mobile communication terminal as recited in claim 7, wherein the new call is selected from the group consisting of a missed call, a received call, and a dialed call.

9. A call history displaying method adapted for a mobile communication terminal, wherein the mobile communication terminal comprises a storage unit for storing communication records and communication frequencies of each of the communication records in a particular time period, the method comprising:
sorting the communication records according to the associated communication frequencies in the particular time period;
reading a predetermined number of the sorted communication records in order;
sorting the read communication records in an alphabetical order to generate a first list;
sorting the remaining communication records of the sorted communication records in the alphabetical order to generate a second list;
merging the first list and the second list to generate a call history of the particular time period, wherein the first list is listed prior to the second list; and
displaying the call history.

10. The call history displaying method as recited in claim 9, wherein the communication records are sorted in descending order according to the associated communication frequencies in the particular time period.

11. The call history displaying method as recited in claim 9, wherein each of the communication records includes a name, a telephone number, a date of the last communication, and a time of the last communication.

12. The call history displaying method as recited in claim 9, further comprising updating the communication records in the particular time period, when the mobile communication terminal generates a new call.

13. The call history displaying method as recited in claim 12, wherein the new call is selected from the group consisting of a missed call, a received call, and a dialed call.
